(19) United States
(12) Patent Application Publication
(10) Pub. No.: US 2011/0079448 A1
(43) Pub. Date: Apr. 7, 2011

(54) Automatic Weight Scale Machine with Unalterd Primary Product Feed Rates and Diverter System

(76) Inventor: Stephen N. Almberg, Joliet, IL (US)

(21) Appl. No.: 12/897,734

(22) Filed: Oct. 4, 2010

Related U.S. Application Data
(60) Provisional application No. 61/278,209, filed on Oct. 3, 2009.

(51) Int. Cl. G01G 13/16; G01G 13/02

(52) U.S. Cl. 177/59; 177/116

(57) ABSTRACT

An automated weighing and filling station that operates without slowing the primary feed transfer. The system includes a bulk product supply, such as a hopper. A primary feed system delivers the product from the bulk product supply to the weighing station which includes two or more independent scale weigh hoppers with a diverter system operating between the two scale weigh hoppers. Each of the scale weigh hoppers empties into a discharge hopper. The primary feed system delivers the product to the diverter system at a constant speed. The diverter system delivers the product from the primary feed system to a first of the scale weigh hoppers until the scale weigh hopper anticipates that the determined weight will be achieved. At that time, the diverter moves the product from the primary feed system to the second of the scale weigh hoppers. The flow of product from the primary feed system is not slowed or stopped, but continues to operate at a constant speed.

### RELATED APPLICATIONS

This application claims the benefit of provisional application 61/278,209 filed on Oct. 3, 2009.

### FIELD OF THE INVENTION

The present invention relates to the field of automatic weigh and fill machines.

### BACKGROUND OF THE INVENTION

Final stage automatic weigh and filling machine are used to produce standard weights or quantities of piece parts for subsequent packaging. In general these machines use a series of vibrating feed trays, gravity or belts to move a flow of piece parts from a bulk supply (or bulk product hopper) into a batching hopper system (bulk hopper supply) that includes a weighing means. This system of transport from the bulk product supply to the bulk hopper supply, is referred to herein as the primary feed system (primary feed system). The batching hopper system includes batching hoppers which include a weight measuring means and are referred to herein as weight scale hoppers (WSH). A precise weight is measured in the WSH(s) and the measure product is transferred to the packing containers. These containers are typically associated with the distribution or sale of a product, thus requiring precise and consistent weights.

Automatic weight scale machine performance is measured in terms of number product fills per/minute. This “fill rate” is often the key parameter used by product manufactures and product packagers in determining which machine to purchase.

Prior art machines typically utilize electronic signals generated by the weighing means to regulate the speed of primary feed system (primary feed system) to slow or to complete stop it as the desired weight is approached. The slowing or stopping of the primary feed system is achieved by altering the vibration applied to the trays or by terminating the vibration altogether. In cases were the feed system uses a belt, the belt is slowed or stopped. Slowing or stopping the primary feed system reduces the fill rate performance of the machine. Slowing the primary feed system rate is referred to as “dribble”. Dribbling or intentionally slowing the product transfer rate is required by prior art machines to achieve the accuracy of weight scale measurement required, however slowing product feed is counter productive to the achieving the machine fill rates desired. One prior art machine described U.S. Pat. No. 5,942,732 (Homes) utilizes a primary feed tray and a smaller capacity “dribble” tray working in combination. This referenced invention and in other prior art devices use a product measurement cycle which includes a step to altering the rate of (i.e. reduction), or interruption of the primary feed system.

Various types of machines have been developed for precision package filling that incorporate a number of different technologies. U.S. Pat. No. 4,095,723 issued to Lerner incorporates a feed pan with two discharge openings leading to a batching hopper. A weighing unit monitors the weight of articles in the bucket and signals a door to close one of the openings as the weight of articles in the bucket approaches a predetermined limit. The weighing unit subsequently signals the feed pan drive to slow and finally stop its feeding action as the limit is reached.

U.S. Pat. No. 4,129,189 issued to Maglecic, controls the weights of charges of product by feeding the product at a high flow rate and then at a relatively low “dribble” flow rate into one or more receiving pans. U.S. Pat. No. 4,664,200, issued to Mikami et al utilizes a plurality of feed troughs adapted to be separately vibrated and radially arranged around the outer periphery of a dispersion table to feed articles to associated weighing units. U.S. Pat. No. 5,473,30 703 issued to Smith uses a photoelectric counting means to vary the speed of the vibratory feed mechanism as does U.S. Pat. No. 5,671,262 issued to Boyer et al. The above referenced patents are incorporated by reference in their entirety.

While many variations exist, the above described designs for prior art package filling machines can be described as follows: a product supply hopper on top is located near the top of the machine; a feeder system which is usually comprised of a vibratory or belt feeder delivers products to scale weigh hopper. The feeder system slows and stops when target weight (set point controlled) is reached based upon scale input. The scale weigh hopper (or hoppers) opens and drops pre-measured amount of product when requested, then the cycle repeats.

### SUMMARY OF THE INVENTION

The present invention provides systems and methods that results in a substantial improvement in the fill rate performance of automatic weight scale machines. The present invention provides systems of precise weighing and machinery control which does not require intentional interruption of, or intentional slowing of the primary feed system during the product packing and measurement cycle. The present invention enables continuous flow of the bulk product in to the batching hopper system and precision weighting of product at an accelerated rate, versus conventional control techniques.

A preferred embodiment of the present invention improves the fill rate of automatic weight scale machines by introducing enhanced control methods which do not require the interruption of the rate at which bulk product is fed in to the batching hopper system. The present invention improves machine performance with out requiring traditionally commensurate increased machine hardware (e.g. more batching hoppers, vibratory feeders or belts).

In one embodiment of the present invention, the system utilizes rate of change in sensed weight to predict when a weighing station is going to be reaching a desired weight without slowing the primary feed system flow rates or without required waiting for a desired set point to be reached.

The control system of a preferred embodiment of the present invention utilizes control algorithms that allow the machine to self adjust to fluctuations in primary feed system rates. It is an advantage of the present invention to utilized a diverter system between the primary feed system and the bulk hopper supply to allow for “touch up” (e.g. incremental) weight adjustment to the weighing stations while not interrupting or slowing the primary feed system.

An embodiment of the present invention provides precision filling of packages with parts or material of various sizes and configurations at commercially realistic speeds. The present invention is able to provide the above described capabilities in an inexpensive and durable machine which is capable of extended duty cycles and that may be easily repaired and maintained.

One embodiment of the present invention includes a diverter system between the primary feed system and bulk hopper supply and is described as follows: a product supply hopper on top; a primary feed system, such as a vibratory or belt feeder, that delivers products to one of two different independent scale weigh hoppers by passing product through a diverter system. The primary feed system is never commanded to slows or stop unless machine is stopped. When a target weight set point is reached based upon scale input the diverter actuating means (e.g. electric cylinder) “moves” to divert product to an empty hopper scale and the full scale weigh hopper opens and drops pre-measured amount of product when requested. The cycle then repeats. If the scale determines that the diverter shuttle (e.g. funnel) “moved” prematurely (or if there was a starve in product flow for some reason) the actuator (e.g. electric cylinder) will “come back” briefly (typically for a split second) and finish the batch hopper fill and meet target weight if needed.

In a preferred embodiment, the diverter system is comprised of a programmable diverter mechanism attached to and controlled by a diverter actuation mechanism. The diverter mechanism may be a flapper, funnel of other appropriate device suitable for diverting flow of the product being handled. In a preferred embodiment the diverter mechanism is a funnel, transfer hopper or chute. The actuation mechanism may be a cylinder, or lever arm operated by electric or pneumatic means.

One preferred embodiment uses a control mechanism (thus the control cycle) that utilizes a “free fall” mode. This mode of control utilizes the rate at which weight in a hopper bin is changing to predict when it will achieve the desired weight. The control algorithm allows for the machine to teach itself based on rate of change while the product is “in flight” (i.e. while the product is in free fall into the weight hopper). This “free fall” mode improves machine speed by anticipating when the desired weight will be achieved based on the current fill rate, rather than waiting for a traditional set point to be reached. The diverter system and the free fall control mode are advantages of the present invention.

An appreciation of the other aims and objectives of the present invention and an understanding of it may be achieved by referring to the accompanying drawings in conjunction with detailed descriptions of a preferred embodiment provided above.

### DESCRIPTION OF THE DRAWINGS

FIG. 1 is a schematic diagram of prior art systems.

FIG. 2 is a schematic diagram of a preferred embodiment of the present invention.

FIG. 3 is an illustration of a front perspective view of the embodiment of FIG. 2.

FIG. 4 is an illustration of a side view of the embodiment of FIG. 2.

FIG. 5 is an illustration of an exploded assembly view.

FIG. 6 is a detail view of the shuttle assembly.

FIG. 7 is a control logic diagram of the present invention.

### DETAILED DESCRIPTION OF PREFERRED EMBODIMENTS

The present invention provides a system for high speed weighing and filling operations. Descriptive embodiments are provided before for explanatory purposes. It is to be expressly understood that the present invention is not be limited to these descriptive embodiments. Other embodiments are considered to be within the scope of the present invention, including without limitation the use of the present invention for other applications, such as other types of weighing, filling and/or packaging operations.

### Overview

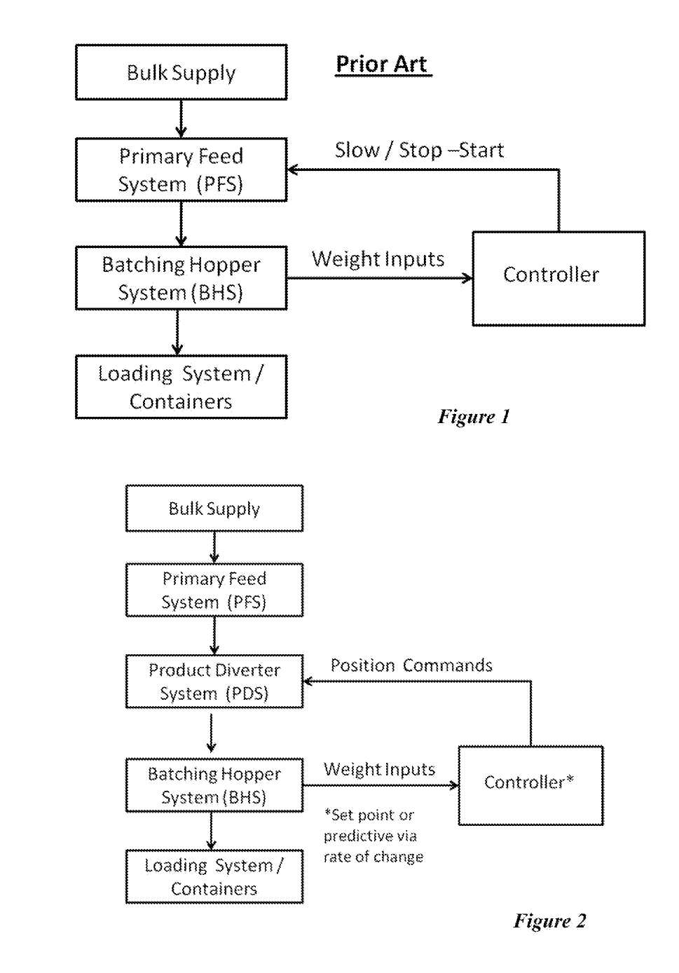

A diagram of the operation of prior art systems is illustrated in FIG. 1. These systems typically use a primary feed system to deliver product from a supply to the weigh station. The primary feed system slows as the predetermined weight is approached until the weight has been reached. The primary feed system stops at that point while the product is delivered to packaging. The present invention increases this fill rate by a factor of three to five times that of traditional weigh and fill systems. The system of this preferred embodiment can be implemented in many forms as discussed in greater detail below.

One embodiment of the present invention includes a weighing and filling system as described in the diagram of FIG. 2. The system includes a bulk product supply, such as a hopper. A primary feed system delivers the product from the bulk product supply to the weighing station. In this preferred embodiment, the weighing station includes two or more independent scale weigh hoppers with a diverter system operating between the two scale weigh hoppers. Each of the scale weigh hoppers empties into a discharge hopper. The scale weigh hoppers can empty into a single discharge hopper or into separate discharge hoppers. The primary feed system delivers the product to the diverter system at a constant speed. The diverter system delivers the product from the primary feed system to a first of the scale weigh hoppers until the scale weigh hopper anticipates that the determined weight will be achieved. At that time, the diverter moves the product from the primary feed system to the second of the scale weigh hoppers. If the weight of product in the first scale weigh hopper is found not to be accurate, then the diverter can move back to the first scale weigh hopper to finish the fill. The flow of product from the primary feed system is not slowed or stopped, but continues to operate at a constant speed.

A preferred embodiment of the present invention provides a final stage automatic weigh and count filling machine feed mechanism that includes a bulk supply, a product feed system (primary feed system), a product diverter system (PDS) and a batching hopper system (bulk hopper supply). The bulk supply (BS) is a quantity of product for feeding in the machine to be weighted, typically held in a hopper. The BS is typically elevated above a primary feed system (primary feed system), and is therefore commonly located near the top of the machine. The primary feed system is defined for the purpose of this application as a system which transfers product from the bulk supply system into the machine (to typically to the batch hopper system). In the present invention, a product diverter system (PDS) is located between the primary feed system and the batching hopper system (bulk hopper supply). It is this Product Diverter System (PDS) which allows for redirection of product flow with out requiring interruption of the primary feed rated. The batching hopper system (bulk hopper supply) includes weight determining means and batches product in predetermined weights for subsequent loading into containers.

The primary feed system may consist of belts, vibratory feed trays (including a vibrating means), or may be a simple gravity feed system. The gravity feed system would include a mechanism for regulating product flow, such as a flapper or valve with an actuator means. The belts, vibratory tray system or gravity feed system includes the ability to be started and stopped via control signals. Optionally these system could utilize various speed setting signal to vary or allow adjustment of product flow rates. In the present invention the rate at which primary feed system operates would not typically require adjustment once the machine has reached a stable operation point. The primary feed may remain at a constant fixed speed (i.e. uninterrupted) during the product weighting and loading cycle.

The PDS is a system with the purpose of directing product flow in to one or more weight scale hoppers in the batching hopper system (bulk hopper supply). In a preferred embodiment of the present invention the bulk hopper supply utilizes at least two weight scale hoppers. The PDS utilizes an actuating means interoperable with a diverter mechanism to direct product flow into the desired weight scale hopper. The actuation means may be any which would be suitable for providing the force required examples of such are: cylinders, (pneumatic, hydraulic or electric), motors, levers, linear drives, or magnetic systems. The diverter mechanism would be chosen to be compatible with the task of diverting product flow in to a desired weight scale hopper. Examples of diverters include without limitation flappers, funnels, trays, valves and manifolds, etc. In a preferred embodiment the diverter mechanism is a funnel actuated by an electric cylinder.

The command signal for controlling the diverter action comes from the machines control system. The signal generated by the control system is based on electronic inputs such as the weight scale inputs, mode selector switch inputs, product weight settings, optional position inputs from the diverter and other command and input signals. The control system utilizes algorithms (or performs logic) in order to perform the required function of the machine. Various modes of operation of the present invention may be utilized for example and without limitation a traditional set point mode or a “free fall” mode of operation may be programmed into the control system. The set point mode waits for the a predetermined weight or set point to be reached then performs a control action such as changing the position of the diverter. The “free fall” mode predicts when a desired weight of product will be collected in a weight scale hopper based on monitoring rate of change in the weight measurement inputs signals. Based on this prediction a control action will be initiated resulting in a change in diverter position. This action will typically result in repeatable and accurate measured amount of product being deposited in the weight scale hoppers. However if the measured weight is less than the predicted value the control algorithm will once the discrepancy is detected, momentarily divert product to the required weight scale bin to correct the deficiency. The control system in the present invention operating in conjunction with the PDS does therefore not required interruption or slowing down of the primary feed system during the normal weighting and loading cycle. As the mode suggests the product is essentially measured while in free fall.

As a fall back mode of operation the present invention (a machine with a diverter system) may be operation in a traditional manner of variable (i.e. interrupting) primary feed. This traditional (but slower) mode of operation may be of use in the event a component of the diverter system is out of service or if a weight scale hopper is not functioning, or in the event the end user did not require the higher rates afforded by the diverter system.

In a preferred embodiment a the primary feed system consist of a first vibratory drive mechanism mounted to a lower mounting surface. The lower surface of the base of the primary feed tray to the first vibratory drive mechanism so that product is transferred along the tray by the action of the first vibratory drive mechanism. The first vibratory drive mechanism may be variable or fixed in speed. However in the preferred embodiment it has variable speed capabilities but operates as a constant fixed speed throughout each weight cycle.

This primary feed pan (i.e. tray) in this preferred embodiment has a front edge, a back wall and a pair of sides defining a conduit extending from the back wall to the front edge. The conduit (which may be V-shaped) has an upper surface and a lower surface. In a preferred embodiment this primary feed tray empties product in to a funnel. The funnel is interoperable with an actuation means which allows the funnels position to be moved quickly from one position to a next position. The position of the diverter mechanism (in this preferred embodiment the funnel) determines which weight scale hopper will receive product flow. The controls system will command the diverter to the required position based on the chosen mode of operation and the weight scale hopper measured signals.

The batching hopper system in the preferred embodiment includes two weight scale hoppers although additional weight scale hoppers could be used. Each hopper in this preferred embodiment includes its own electronic weight measuring instruments which are then intern interconnected to the control system of the machine. Once the proper weight is in the batching hoppers the hoppers will deposit their load into the subsequent packing container system, as commanded. Flappers or other mechanical means of releasing or restricting flow from the hoppers are controlled by the control system based on the correct weight and the preparedness of the containers for receiving product flow.

A weigh scale hopper system is located adjacent to and below the output of the diverter system. The batching hopper system includes a plurality of weight measuring means, one each associated with each weight scale hopper.

A mechanism responsive to the amount of weight detected by the weight measuring means is adapted to control the position of the diverter mechanism. In operation, when the material received in a batching hopper approaches a set point (or in a preferred mode of this invention is predicted to be approaching a weight limit based on a correlation of rate of weight change) the diverter mechanism begins to change position redirecting flow to an alternate hopper. In the event the weight measured was less than the set point target, the diverter would be commanded (momentarily) back to its previous position. The primary feed system is not required to be stopped or slowed down during this process, as long as the downstream packing system can handle the product flow rates. Finally, when the packing system indicates it is ready to receive material a weigh scale hopper will release its product and the cycle continues. The packing system may include an inlet funnel.

### Exemplary Implementations

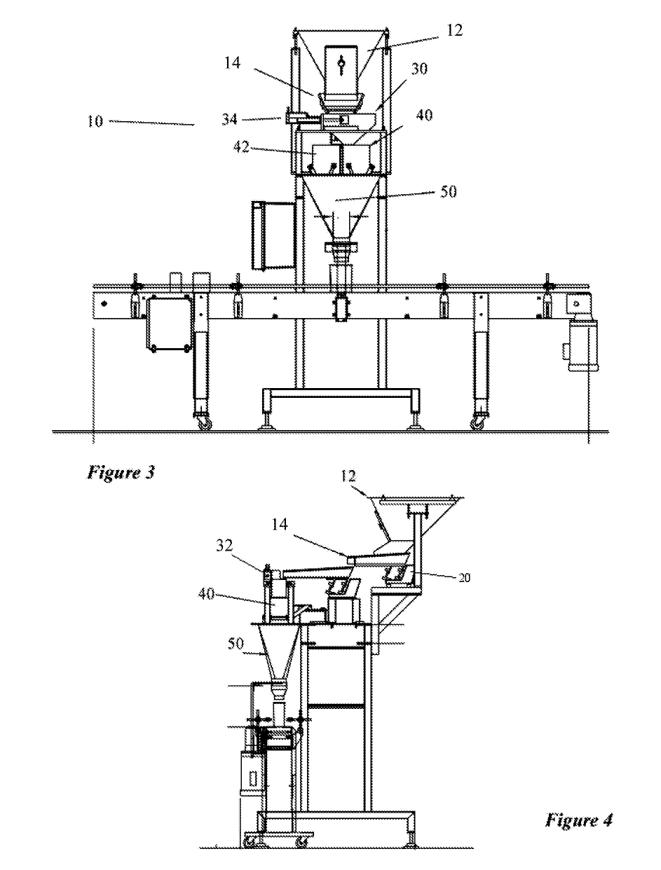

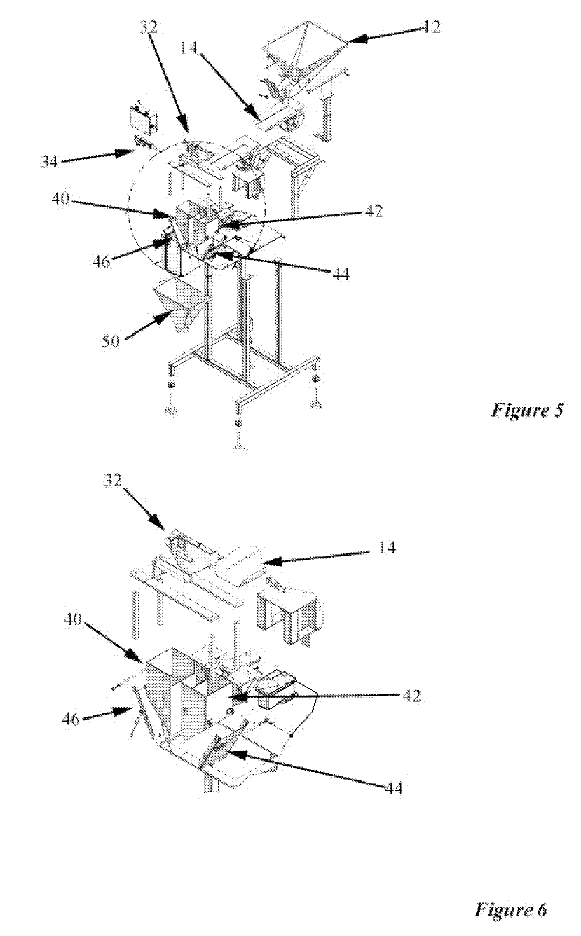

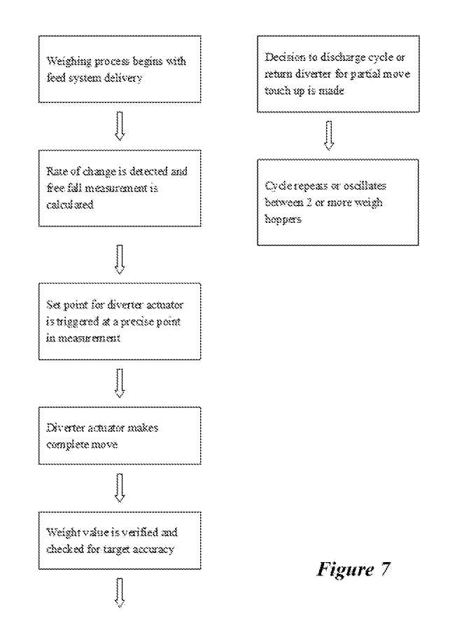

A preferred embodiment of a implementation of the present invention is illustrated in FIGS. 3-7. This embodiment includes a free fall weigh and fill machine 10 having a bulk supply hopper 12 mounted at the top of the machine. The bulk supply hopper 12 discharges product via feed tray 14 to the primary feed supply 20. In this embodiment, the primary feed supply 20 is a vibratory feed pan or tray, but other feed mechanisms could be used as well such as a conveyor, feed screw, gravity or other feeding mechanisms. The primary feed supply 20 delivers the product from the supply hopper 12 to the diverter 30. In this embodiment, the diverter is a shuttle chute 32. It is to be expressly understood that other mechanisms could be used as well for the diverter, including a funnel, flapper, manifold or any other mechanism that can change the direction of flow. A drive cylinder 34 is connected to the shuttle chute 32. In this embodiment, the drive cylinder can be hydraulic, pneumatic, solenoid, lever, screw or other actuating mechanisms.

Two weight buckets 40, 42 are mounted beneath the diverter 30. Each of the weight buckets are connected to weighing mechanisms and to the control mechanism. Bucket doors 44, 46, are mounted to the weight buckets 40, 42 respectively. A control mechanism for each of the doors control the opening and closing of the doors. The final discharge chute 50 is mounted beneath the bottom openings of the weight buckets.

In operation, as shown in the diagram of FIG. 6, the product is transferred from the bulk supply hopper 12 via the feed tray 14 and primary feed supply 20 to the diverter 32. The product is fed via the diverter into the first of the weight buckets. A sensing mechanism is used to anticipate when the weight bucket meets the predetermined weight of product. This mechanism can be a free fall mechanism which uses the rate at which the weight in the weight bucket is changing to predict when the weight bucket will achieve the predetermined rate, or it can use a timing mechanism to predict this point or another sensing mechanism to determine when the weight will be met. Once the mechanism determines the anticipated time, the diverter is then moved by the drive cylinder to the second weight bucket to direct product flow to the second weight bucket at that time and begins to fill the second weight bucket. If the system determines that the first weight bucket did not achieve the predetermined weight, the diverter is moved back to the first weight bucket for a short period of time to fill the first weight bucket. This can be done in short bursts so not to overfill the first weight bucket.

Once each of the weight buckets have reached their predetermined weights, the control mechanism opens the appropriate bucket door to allow the product to drop into the final discharge chute where the appropriate packaging will be receive it.

The primary feed system continues to operate at full speed during the entire operation rather than slowing or stopping as the weight buckets are filled. This increases the throughput of the operation tremendously to provide a more efficient operation.

It is to be expressly understood that the above description of a preferred embodiment is intended for explanatory purposes only and is not meant to limit the scope of the claimed inventions. Other embodiments are considered to be within the scope of the claimed inventions.

What is claimed is:

1. A system for weighing product and filling packaging, said system comprising:
a supply source for holding product;
a diverter mechanism;
a transfer mechanism for transferring product from said supply source to said diverter mechanism;
a first weighing station;
a second weighing station;
a drive mechanism for moving said diverter mechanism from a first position to allow product from said supply source to fill said first weighing station to a second position to allow product from said supply source to fill said second weighing station; and
a control mechanism for sensing when said first weighing station will reach a predetermined weight and when said second weighing station will reach a predetermined weight and for operating said drive mechanism to move said diverter to and from said first position and said second position as said first weighing station and said second weighing stations reach their respective predetermined weights.

2. The system of claim 1 wherein said diverter mechanism includes:
a funnel for diverting product from said transfer mechanism between said first weighing station and said second weighing station.

3. The system of claim 1 wherein said diverter mechanism includes:
a flapper for diverting product from said transfer mechanism between said first weighing station and said second weighing station.

4. The system of claim 1 wherein said diverter mechanism includes:
a manifold for diverting product from said transfer mechanism between said first weighing station and said second weighing station.

5. The system of claim 1 wherein said control mechanism includes:
a sensor for sensing the rate of change of weight of each of said weighing stations to predict when the weighing station will reach the predetermined weight.

6. The system of claim 1 wherein said control mechanism includes:
a sensor for sensing when the weight of each of said weighing stations has reached a set point for the predetermined weight.

7. The system of claim 1 wherein said system further includes:
a final discharge station for receiving product from each of said weighing stations for discharging the product from each weighing station into packaging.

8. A system for weighing product and filling packaging, said system comprising:
a supply source for holding product;
a diverter mechanism;
a transfer mechanism for transferring product from said supply source to said diverter mechanism;
a first weighing station;
a second weighing station;
a drive mechanism for moving said diverter mechanism from a first position to allow product from said supply source to fill said first weighing station to a second position to allow product from said supply source to fill said second weighing station;
a control mechanism for sensing when said first weighing station will reach a predetermined weight and when said second weighing station will reach a predetermined weight and for operating said drive mechanism to move said diverter to and from said first position and said second position as said first weighing station and said second weighing stations reach their respective predetermined weights; and
a final discharge station for receiving product from each of said weighing stations for discharging the product from each weighing station into packaging.

9. The system of claim 8 wherein said control mechanism includes:
a sensor for sensing the rate of change of weight of each of said weighing stations to predict when the weighing station will reach the predetermined weight.

10. The system of claim 1 wherein said control mechanism includes:
a sensor for sensing when the weight of each of said weighing stations has reached a set point for the predetermined weight.

11. A method for weighing and filling product from a bulk supply, said method comprising the steps of:
transferring product from a bulk supply source at a constant speed by a feed supply system;
receiving product from said feed supply system to a diverter mechanism;
diverting the product by said diverter mechanism between two weighing stations based on the product reaching a predetermined weight in the weighing stations; and
discharging the product from each of the weighing stations into containers.

12. The method of claim 11 wherein said step of diverting the product by said diverter mechanism between at least two weighing stations includes:
predicting the time at which product in each of the weighing stations will reach the predetermined weight by sensing the rate of change of weight in the weighing stations.

13. The method of claim 11 wherein said step of diverting the product by said diverter mechanism between at least two weighing stations includes:
determining the point at which product in each of the weighing stations has reached the predetermined weight.

14. The method of claim 11 wherein said method further includes the step of:
moving the diverter back to the previous weighing station if the weighing station did not reach the predetermined weight.
